(19) United States
(12) Patent Application Publication
(10) Pub. No.: US 2025/0383941 A1
(43) Pub. Date: Dec. 18, 2025

(54) SYSTEMS AND METHODS FOR APPLICATION PROGRAMMING INTERFACE (API) ONBOARDING USING API ONBOARDING TEMPLATES THAT GENERATE FEATURE INPUTS FOR ARTIFICIAL INTELLIGENCE MODELS

(71) Applicant: Capital One Services, LLC, McLean, VA (US)

(72) Inventors: David DUONG, Plano, TX (US); Carel DE BRUYN, Prosper, TX (US); Alit PONKAEW, Allen, TX (US)

(73) Assignee: Capital One Services, LLC, McLean, VA (US)

(21) Appl. No.: 18/747,328

(22) Filed: Jun. 18, 2024

(51) Int. Cl. G06F 9/54; G06N 20/00

(52) U.S. Cl. CPC G06F 9/54; G06N 20/00

(57) ABSTRACT

Systems and methods provide an API onboarding template that comprises customized fields for characteristics of the new API, its code, its functions, required tests, and/or dependencies of the new API. The system may generate a feature input for an artificial intelligence model that is trained to generate a plurality of REST requests based on audited and/or archived data from the actual production application raises yet another technical challenge.

### BACKGROUND

An API (Application Programming Interface) is a set of rules and protocols that allows different software applications to communicate with each other. It defines the methods and data formats that applications can use to request and exchange information. APIs provide a way for different software systems to interact without needing to understand each other's internal workings. APIs typically consist of endpoints, which are specific URLs where particular functions or data can be accessed. When an application makes a request to an API, it sends a specific set of instructions (often called a “request”). The API then processes this request and sends back the requested data or performs the requested action (often called a “response”). Many APIs use standard HTTP methods such as GET (to retrieve data), POST (to send data), PUT (to update data), and DELETE (to remove data). APIs often require authentication and authorization to ensure that only authorized users can access certain data or perform certain actions. APIs often use standard data formats like JSON (JavaScript Object Notation) or XML (eXtensible Markup Language) for exchanging data, which makes it easier for different systems to understand and use the data.

A new API may be integrated into an application or system through AIP onboarding. This process ensures that the new API functions correctly and effectively within the existing framework. During onboarding, developers may obtain the necessary authentication credentials, such as API keys or tokens, often involving registration with the API provider. The developers may perform initial test calls to the API to familiarize with its behavior and to troubleshoot any issues with the application or system. This testing phase is crucial for verifying that the API's responses are correctly handled and integrated into the application's workflows. Error handling, logging, and monitoring mechanisms are implemented to ensure the API's performance and reliability. Once the API is successfully integrated and tested, it is moved into the production environment, where ongoing maintenance and updates are managed to keep the API functioning optimally within the application.

### SUMMARY

Systems and methods are described herein for novel technical features and/or improvements to the API onboarding process. For example, in existing systems, API testing is typically done in a siloed approach where new APIs are tested only for specific scenarios, and the tests themselves are customized to known attributes of those specific scenarios. Not only does this mean that new APIs are largely untested outside these specific scenarios, but even within those scenarios, any test may be limited to, biased by, and/or overfitted to the known attributes. Further complicating these issues, the tests are typically developed and written by the developers of the new API (as only these developers are familiar with the script and functions of the new API). However, these developers are typically not intimately familiar with the specifications for the application. Accordingly, the developers cannot adjust the tests outside the specific scenarios and/or known attributes of those specific scenarios.

In view of these technical problems, the systems and methods use a novel approach to API onboarding. In particular, the systems and methods overcome the limited familiarity that developers may have with the application or system by providing an API onboarding template that comprises customized fields for characteristics of the new API, its code, its functions, required tests, and/or dependencies of the new API. Through the use of the template, the system may compensate for the developer's limited knowledge of the application or system.

However, even through the use of the API onboarding template, new APIs would still be tested only for specific scenarios in the templates and/or any known attributes listed in the templates. Accordingly, as opposed to using the API onboarding template as a submission to a testing protocol for the application or system (e.g., directly submitting the API onboarding template populated by the developers for testing), the system instead generates a feature input for an artificial intelligence model that is trained to generate a plurality of REST (Representational State Transfer) requests based on audited and/or archived data from the actual production application. By doing so, the system generates a pool of REST requests that mimic actual production use cases (e.g., synthetic REST requests). Furthermore, as the REST request and/or response are processed the system may iteratively update the plurality of REST requests for a dynamic stress test.

For example, the onboarding process begins by the system issuing the plurality of initial REST requests to the API's endpoints to understand their functionality and responses. These requests may use standard HTTP methods such as GET to retrieve data, POST to submit data, PUT to update data, and DELETE to remove data. By sending these requests, the system can validate that the API endpoints return the expected data and perform the intended actions. If not, the system may identify any discrepancies or issues that need to be addressed. The system may then iteratively update the REST requests that are generated based on the responses to test different scenarios and error handling, ensuring the application can gracefully manage various API responses, including success, errors, and edge cases. Through this iterative process of sending and analyzing REST requests, the system may iteratively generate new pools of REST requests that can fine-tune the integration, ensuring that the API works seamlessly with the application.

Unfortunately, generating a feature input for an artificial intelligence model that is trained to generate a plurality of REST requests based on audited and/or archived data from the actual production application raises yet another technical challenge. Specifically, training a model on REST requests and responses presents technical challenges due to the complexity and variability inherent in API interactions. One primary difficulty lies in the diversity of APIs, each with its own unique endpoints, data structures, authentication mechanisms, and error handling protocols. This diversity means that the training data must encompass a wide range of different APIs to ensure the model can generalize effectively, which can be difficult to gather and standardize. Additionally, RESTful APIs often involve dynamic and contextual data, meaning that the same request might yield different responses based on factors such as user state, time of request, or backend server conditions. This variability makes it challenging to create a consistent training dataset that accurately represents all possible scenarios.

Furthermore, REST requests and responses typically involve complex nested data structures, often in formats like JSON or XML, which require the model to understand and process hierarchical information accurately. Parsing and interpreting these structures correctly adds another layer of complexity to the training process. Another significant challenge is handling authentication and authorization, as many APIs require secure access tokens or keys that need to be managed carefully to avoid security breaches during training. This requires simulating secure environments and ensuring that sensitive information is protected, adding to the technical overhead.

Finally, the model must be capable of handling error responses and exceptional cases gracefully, which involves training on a broad spectrum of potential error codes and messages that APIs might return. This necessitates a comprehensive and well-curated dataset that covers not just successful interactions but also a wide range of failure scenarios. In view of these technical challenges related to training an artificial intelligence model, the system formats the feature input based on a subset of training data that is audited and/or archived data from the actual production application corresponding to the same category of API. By doing so, the system mitigates the technical difficulty of training a model on REST requests and responses that stems from the need to handle diverse, dynamic, and complex data, ensure security, and/or cover a broad array of potential interactions comprehensively.

In some aspects, systems and methods for API onboarding using API onboarding templates that generate feature inputs for artificial intelligence models trained on subsets of audited and/or archived API data from production application data are described. For example, the system may receive a first user request to onboard a first API to a first application. The system may determine a first API function type for the first API. The system may select a first API onboarding template from a plurality of API onboarding templates based on the first API function type corresponding to the first API onboarding template. The system may populate the first API onboarding template to generate a populated template using one or more API characteristics for the first API. The system may generate, based on the populated template, a first feature input for a first artificial intelligence model. The system may input the first feature input into the first artificial intelligence model to generate a first output, wherein the first artificial intelligence model is trained to generate synthetic requests using first training data, and wherein the first training data comprises subsets of historical requests and responses transmitted by APIs previously onboarded to the first application labeled with a given function type. The system may determine a first plurality of synthetic requests. The system may execute the first plurality of synthetic requests to receive a first plurality of synthetic responses. The system may determine whether to onboard the first API based on validating the first plurality of synthetic responses.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for an API onboarding template, in accordance with one or more embodiments.

FIG. 2 shows an illustrative diagram for system for API onboarding using an API onboarding template, in accordance with one or more embodiments.

FIG. 3 shows illustrative components for a system used to perform API onboarding using an artificial intelligence model, in accordance with one or more embodiments.

FIG. 4 shows a flowchart of the steps involved in API onboarding using an API onboarding template, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

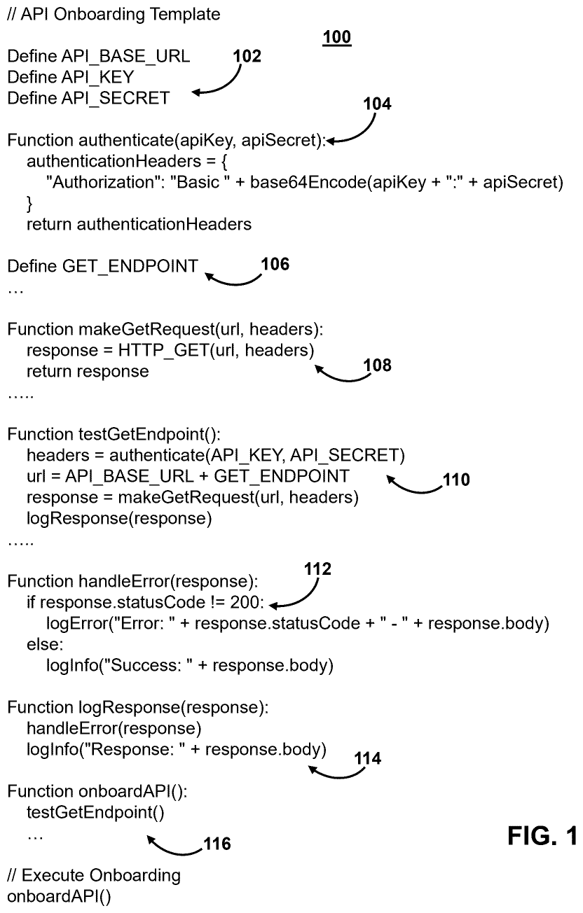

FIG. 1 shows an illustrative diagram for an API onboarding template, in accordance with one or more embodiments. For example, pseudocode 100 may comprise code used for API onboarding using API onboarding templates that generate feature inputs for artificial intelligence models trained on subsets of audited and/or archived API data from production application data. For example, pseudocode 100 may represent script or code in an API onboarding template. In one instance, a developer may wish to onboard an API with one or more functions and/or for use in one or more scenarios. APIs allow developers to leverage existing services and data without having to build these capabilities from scratch. For example, a developer might integrate a payment processing API to handle transactions securely and efficiently, rather than developing their own payment system, which would require significant time, resources, and expertise. Similarly, integrating a weather API could provide real-time weather updates, enhancing the application's user experience with minimal effort. Onboarding an API with multiple functions can address different needs within the same application. For instance, a social media API might offer functions for posting updates, retrieving user data, and analyzing social trends. By integrating these functions, a developer can build a robust, feature-rich application that meets various user needs. Additionally, using an API in multiple scenarios can improve the application's versatility. An e-commerce platform might use an API for inventory management, customer relationship management, and logistics tracking, ensuring smooth operation across different aspects of the business. Moreover, APIs can facilitate scalability and maintenance. When using third-party services through APIs, developers can benefit from the continuous improvements and updates provided by the API provider, ensuring that the application remains up-to-date with minimal effort. This approach also allows the application to scale more easily, as developers can add new functionalities or expand existing ones by integrating additional API endpoints.

Using pseudocode 100, the system may extend API onboarding classes to show required functionality. For example, to extend a base class for specific APIs, developers may create subclasses that inherit from the base class. These subclasses can override or extend the base class methods to implement the particular functionality needed for each API. For example, if the base class has a generic authenticate method, a subclass for a specific API might override this method to include additional steps required by that API's authentication process. Similarly, while the base class might include a generic “makeRequest” method, a subclass can extend this method to handle API-specific request formats or parameters. Moreover, the subclasses can include additional methods tailored to the specific endpoints and operations of the API they are integrating. For instance, a subclass for a social media API might have methods like “postStatusUpdate,” “fetchUserProfile,” and “getTrendingTopics,” each using the base class's HTTP request methods but adding the specific logic and endpoint details required for those operations.

Pseudocode 100 may also use a code data gathering process for a specific need with filters being used. For example, an API onboarding template may utilize a code data gathering process with filters to tailor the integration to specific needs effectively. The process may begin with defining the API endpoints and specifying the parameters required for data retrieval. These parameters may include filters that refine the data according to the application's requirements, such as date ranges, categories, or user-specific data. The template provides a structured way to input these filters, ensuring that only the relevant data is requested from the API. For example, a developer onboarding a weather API might include filters for location, date, and weather conditions to gather specific data needed for a weather forecasting application. The onboarding template allows the developer to specify these filters in the request parameters, ensuring that the API returns only the pertinent data. This not only reduces the amount of unnecessary data processed by the application but also improves efficiency and performance.

The template includes functions for constructing API requests with these filters, handling authentication, and managing responses. When the API request is made, the template ensures that the filters are applied correctly, resulting in a targeted data retrieval process. Upon receiving the response, the template processes and validates the data, ensuring it meets the specific needs outlined by the filters. This structured approach allows developers to focus on integrating the exact data required for their application, minimizing overhead and streamlining the development process. Moreover, the use of filters in the onboarding template helps maintain clarity and organization within the code. By encapsulating the data gathering process within well-defined functions, the template promotes reusability and scalability, making it easier to adjust filters or add new ones as requirements evolve.

Pseudocode 100 may generate REST requests of API being onboarded with marking of fields wanting to be changed and/or different possible values. For example, the system may generate REST requests for an API being onboarded by providing a structured template that allows developers to mark fields they want to change and specify different possible values. This process typically begins with the creation of a base request template that outlines the standard structure and required fields for the API endpoints. The template includes placeholders for dynamic fields, such as query parameters, headers, and body content, which can be easily modified.

Within this template, developers can annotate or mark fields that are subject to change, indicating which parameters can be adjusted and specifying their potential values. For instance, in a weather API request, fields like “location,” “date,” and “units” might be marked as configurable. Developers can then input various values for these fields, either manually or through a predefined list of options. This approach allows for flexibility in generating different requests tailored to specific needs without altering the core structure of the template.

To facilitate this process, the system may provide a user interface or configuration file where developers can input their desired changes. The system dynamically updates the request template based on these inputs, generating the appropriate REST requests. Additionally, the system can support the use of variables and loops to automate the generation of multiple requests with different combinations of values. For example, if testing various date ranges and locations, the system can iterate through these values, creating a series of requests to cover all possible scenarios.

Once the requests are generated, the system can send them to the API, handle responses, and log outcomes. This automated approach ensures that all necessary variations of the request are tested, reducing manual effort and minimizing the risk of errors. By marking fields for change and allowing multiple values, the system provides a flexible and efficient way to generate and manage REST requests, ensuring comprehensive coverage during the API onboarding process. This methodology enhances the ability to customize and validate the integration, making it more robust and adaptable to varying requirements.

To achieve these features, pseudocode 100 may include various sets of script. Script 102 may allow a user to define various API characteristics. For example, an API onboarding template may provide a structured approach for developers to input and manage various aspects of an API's integration into an application. The template typically includes fields for receiving key API characteristics, such as the base URL, authentication keys, and secret tokens, ensuring that the necessary connection details are easily accessible and modifiable. Additionally, the template may outline the code required to authenticate with the API, including functions for generating authorization headers. As described herein, an API characteristic may be any attribute that distinguishes one API from another.

Using script 102, the template may receive various characteristics that need to be tested. For example, the connectivity and authentication mechanisms must be verified. This involves testing the API keys, tokens, or OAuth processes to ensure that the application can successfully authenticate and communicate with the API. Additionally, each endpoint may provide by the API should be tested for its functionality. This includes making GET requests to retrieve data, POST requests to submit new data, PUT requests to update existing data, and DELETE requests to remove data. For each type of request, the correct handling of request parameters and headers needs to be validated to ensure that the API responds accurately and as documented.

The API may also be tested for its response to various error conditions, such as invalid inputs, missing required parameters, unauthorized access attempts, and server errors. This helps ensure that the application can gracefully manage these errors without crashing or providing misleading information to users. Additionally, performance and rate limiting tests are important to evaluate how the API handles high volumes of requests and adheres to any rate limits imposed by the provider. This helps in understanding the API's reliability and scalability under different load conditions. Documentation and consistency are also key characteristics to verify. The responses from the API should be consistent with the documentation provided, including data formats (such as JSON or XML) and the structure of the responses. Finally, security tests should be conducted to ensure that data transmitted between the application and the API is secure and that the API does not expose any vulnerabilities that could be exploited. By thoroughly testing these characteristics, developers can ensure that the API functions correctly, securely, and efficiently within their application environment.

Script 104 may be used for authentication. For example, script 104 may include placeholders for necessary authentication information such as API keys, tokens, client IDs, and secrets, which are typically outlined in the API's documentation. Users may input these credentials into the template, ensuring that the authentication details are correctly formatted and ready for use in API requests. The template then defines functions to handle the various authentication methods supported by the API, such as Basic Authentication, OAuth, or Bearer Tokens. For instance, if an API requires an OAuth token, the template will include a sequence of steps to obtain the token, such as making a POST request to the token endpoint with the client ID and secret. It will also handle the parsing of the token from the response and storing it for use in subsequent requests.

To test the authentication, the template may generate and send a series of initial requests using these credentials to endpoints that require authentication. For example, it might send a simple GET request to a protected endpoint and check the response status code. A successful authentication typically results in a “200 OK” status, indicating that the credentials are valid and the API has granted access. Conversely, a “401 Unauthorized” or “403 Forbidden” status may indicate a problem with the authentication process, prompting the user to recheck the credentials or the authentication flow defined in the template. The system may also include error handling and logging mechanisms to capture and report any issues encountered during the authentication tests. This helps users quickly diagnose and resolve problems, ensuring that the authentication process is robust and reliable. By automating these steps, the onboarding template streamlines the testing of authentication methods, reducing manual effort and minimizing the risk of errors. It ensures that the API integration starts on a solid foundation with secure and verified access to the API's resources.

Script 106 defines endpoints. An API onboarding template may use API characteristics to define endpoints of an API by providing a structured framework that incorporates the specific details required to interact with the API's various functions. This begins with the template including a section where the base URL of the API is specified, which serves as the foundation for constructing endpoint URLs. The base URL is typically provided in the API documentation and is a constant across all endpoint definitions. The template then allows users to define specific endpoints by appending paths to the base URL. These paths correspond to different API resources and actions, such as retrieving data, submitting data, updating records, or deleting entries. For instance, an endpoint for fetching user details might be defined by adding/users/{userId} to the base URL, where {userId} is a placeholder for dynamic user-specific values. The template uses these placeholders to make the endpoints adaptable to various inputs.

The template may include fields for specifying query parameters, headers, and request bodies that are required for interacting with these endpoints. Query parameters might include filters, sorting options, or pagination details, while headers often contain authentication tokens and content type specifications. For example, a GET request to an endpoint might include parameters like “?sort=asc&limit=10,” which the template formats and appends to the endpoint URL.

Script 108 defines helper functions. For example, an API onboarding template may use API characteristics to define helper functions by encapsulating common tasks and operations required to interact with the API efficiently and consistently. These helper functions are designed to handle repetitive or complex actions that developers frequently need to perform, thereby simplifying the process of making API calls and processing responses. The template may analyze the API documentation to identify common patterns and requirements across different endpoints. This includes understanding the necessary authentication methods, request formats, and response structures. Based on this analysis, the template defines helper functions for tasks such as setting up authentication headers, constructing URL strings with query parameters, and parsing JSON or XML responses.

For example, a helper function for authentication might automatically include API keys or tokens in the headers of each request. This function ensures that every request made through the API client is properly authenticated without requiring the developer to manually add the authentication details each time. Similarly, a function for constructing URLs might take a base URL and a set of query parameters as inputs, combining them into a correctly formatted endpoint URL. Additionally, the template includes functions for handling different HTTP methods (GET, POST, PUT, DELETE). These functions abstract the details of making HTTP requests, allowing developers to simply call a method like “makeGetRequest(endpoint, params)” or “makePostRequest(endpoint, body)” without worrying about the underlying implementation. These methods manage the setup of headers, the serialization of request bodies, and the handling of responses. The template can define functions to check for common error responses and handle them appropriately, such as retrying requests, logging errors, or raising exceptions with meaningful messages. This ensures that the application can gracefully handle various error scenarios and provides developers with clear feedback on what went wrong. By defining these helper functions, the API onboarding template abstracts the complexity of interacting with the API, allowing developers to focus on integrating the API's functionality into their application rather than dealing with low-level details. This modular approach also promotes code reuse and consistency, as common tasks are centralized in well-defined functions that can be easily maintained and updated. Overall, the use of helper functions in the onboarding template streamlines the API integration process, making it more efficient and less error-prone.

Script 110 tests endpoints. For example, the API onboarding template may use API characteristics to test endpoints by automating the creation and execution of test cases that validate the functionality, reliability, and performance of the API endpoints. This process starts with incorporating the API's base URL and endpoint paths into the template, allowing for the dynamic generation of complete request URLs based on the API documentation. The template also includes predefined test scenarios and data that align with the API's specifications, ensuring comprehensive coverage of the API's capabilities. For each endpoint, the template may define a series of test cases that simulate typical and edge-case interactions. These test cases include various HTTP methods (GET, POST, PUT, DELETE), with appropriate query parameters, headers, and request bodies. For example, a GET request to a user endpoint might include tests for retrieving a user by ID, handling pagination, and applying filters. The template sets up these requests with different combinations of inputs to thoroughly test the endpoint's behavior. The template may also integrate validation logic to check the responses against expected outcomes. This includes verifying the status codes, response times, and the structure and content of the response data. For instance, if an endpoint is expected to return a list of users, the template will check that the response contains an array of user objects with the correct attributes. Additionally, the template can validate the handling of error conditions, such as missing required parameters or unauthorized access, by sending requests designed to trigger these errors and ensuring the API responds appropriately.

To facilitate these tests, the template might use a testing framework or tool that supports API testing, such as Postman, JUnit, or pytest. These tools allow for the automation of test execution and provide detailed reports on the results, highlighting any failures or deviations from expected behavior. The onboarding template configures these tools with the necessary scripts and test cases, enabling developers to run the tests with minimal setup. By using API characteristics to define and execute these tests, the onboarding template ensures that each endpoint is thoroughly vetted before being integrated into the application. This automated testing approach helps identify issues early in the development process, reducing the risk of bugs and enhancing the reliability of the API integration. Ultimately, this leads to a more robust and efficient onboarding process, ensuring that the API functions correctly and meets the application's requirements.

The template also defines the endpoints for different HTTP methods (GET, POST, PUT, DELETE), allowing users to specify the paths and parameters for each endpoint. Functions within the template handle the actual API requests and responses, encapsulating the logic for making calls, processing results, and managing errors. The template also includes fields and placeholders for required tests, ensuring that each endpoint and function is verified for correct operation. This might involve test functions that send sample requests and log responses, checking for successful communication and correct data handling. Furthermore, the template can specify dependencies, such as libraries or modules needed for making HTTP requests or parsing responses, ensuring that all necessary components are in place before integration begins. By organizing these elements into a cohesive template, developers can streamline the onboarding process, ensuring consistency and completeness while integrating APIs into their applications.

Script 112 may define error handling. For example, the API onboarding template uses API characteristics to define error handling by incorporating mechanisms that identify, manage, and respond to various types of errors that might occur during API interactions. The template may begin by categorizing potential errors, such as client-side errors (4xx), server-side errors (5xx), network issues, and authentication failures. Each category is addressed with specific handling procedures to ensure that the application can gracefully manage these situations. The template may include functions that automatically check the status codes of API responses. For example, if a response returns a 401 Unauthorized status, the template might trigger a function that refreshes the authentication token or prompts the user to re-authenticate. Similarly, for 404 Not Found errors, the template can log the issue and provide fallback mechanisms, such as displaying an error message to the user or retrying the request with modified parameters.

In addition to status code checks, the template may also define procedures for parsing error messages contained within the response body. Many APIs return detailed error information in the response payload, which can provide insights into what went wrong. The onboarding template can include functions that extract these error messages and use them to generate more informative and user-friendly error messages within the application. For network-related errors, such as timeouts or connectivity issues, the template might implement retry logic with exponential backoff. This approach involves retrying the request after progressively longer intervals, which helps manage transient network issues without overwhelming the server with repeated requests.

Script 114 may define logging procedures. For example, the template may also incorporate logging and monitoring features to track errors systematically. By logging error details, such as the endpoint called, the parameters used, and the response received, developers can gain valuable insights into recurring issues and their root causes. Monitoring tools can alert developers to significant or unusual error rates, enabling proactive troubleshooting and maintenance.

By using API characteristics to define comprehensive error-handling strategies, the onboarding template ensures that the application can manage errors effectively, maintaining robustness and a positive user experience. This systematic approach to error handling helps minimize the impact of issues on end-users and facilitates easier debugging and maintenance for developers. Ultimately, it leads to a more reliable and resilient API integration.

Script 116 may define main onboarding workflow. For example, an API onboarding template may use API characteristics to define the main onboarding workflow by providing a structured, step-by-step process that ensures thorough and efficient integration of the API. This workflow may be tailored based on the API's documentation, encompassing authentication, endpoint setup, request formatting, error handling, and testing procedures. The onboarding workflow begins with authentication, where the template includes mechanisms to handle various authentication methods such as API keys, OAuth tokens, or JWTs. This ensures that every request sent to the API is properly authenticated, providing secure access to the API's resources.

Once authentication is set up, the workflow moves to endpoint definition. The template uses the API's base URL and endpoint paths (as defined) to create a map of all the available endpoints. It incorporates placeholders for dynamic parameters and query strings, allowing users to easily configure and customize requests. The template also outlines the required headers, request bodies, and supported HTTP methods for each endpoint, ensuring that all interactions with the API adhere to its specifications.

The template may then use the defined helper functions for common operations, such as constructing requests, parsing responses, and handling errors. These functions abstract away the repetitive and complex parts of working with the API, making it easier for developers to implement the API's functionality in their application. For example, a helper function might automatically format and send a GET request to fetch data from a specific endpoint, handling all the necessary details like setting headers and parsing the response.

The workflow may also include comprehensive testing procedures (as defined). The template may set up automated tests for each endpoint, using predefined test cases that cover typical usage scenarios and edge cases. These tests validate that the API responds correctly and reliably under different conditions, checking for correct status codes, response formats, and handling of error cases. This ensures that any issues are identified and resolved early in the integration process.

By using these API characteristics to structure the onboarding workflow, the template ensures a comprehensive, consistent, and efficient integration process. It guides developers through each necessary step, from initial setup to final testing, ensuring that the API is integrated correctly and functions as expected within the application. This systematic approach reduces the likelihood of errors, streamlines development, and enhances the overall reliability and performance of the API integration.

In some embodiments, pseudocode 100 may be present on a user interface. As referred to herein, a “user interface” may comprise a human-computer interaction and communication in a device, and may include display screens, keyboards, a mouse, and the appearance of a desktop. For example, a user interface may comprise a way a user interacts with an application or a website.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic” may include about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be digital representation of a person's identity. The data in the user profile may be generated based on the system actively or passively monitoring.

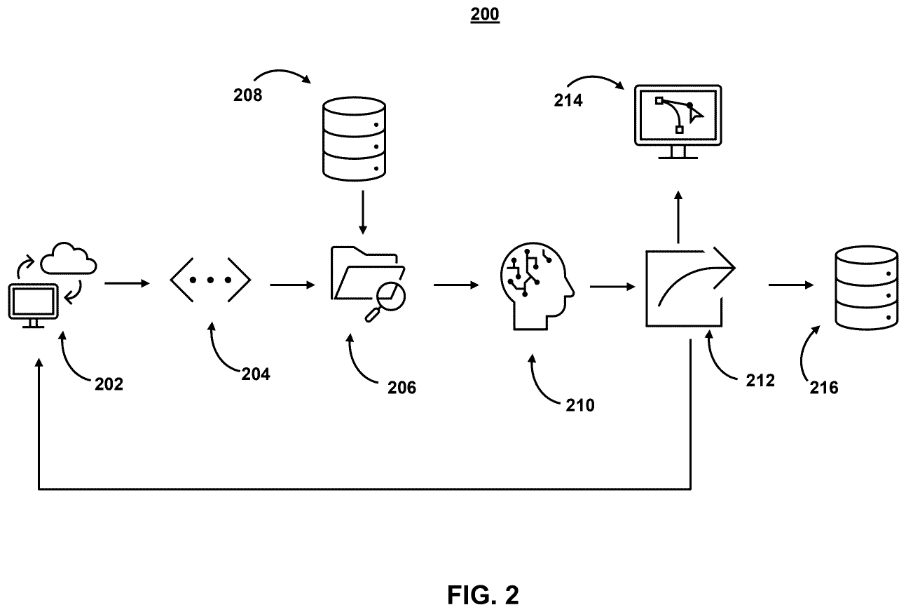

FIG. 2 shows an illustrative diagram for system for API onboarding using an API onboarding template, in accordance with one or more embodiments. For example, process 200 may be used for API onboarding using API onboarding templates that generate feature inputs for artificial intelligence models trained on subsets of audited and/or archived API data from production application data.

Process 200 may begin at user interface 202. At user interface 202, the system may receive a first user request to onboard a first API to a first application. The system may determine a first API function type for the first API. In some embodiments, the system may determine an API function type based on the groups and/or categories of APIs already onboarded. The system may conduct an analysis of the existing API inventory, categorizing them based on their functionalities, use cases, and/or the domains they serve. This involves identifying common patterns and functionalities among the onboarded APIs, such as data retrieval, data manipulation, authentication, or integration tasks. By leveraging this categorized data, the system can map out the functional landscape and pinpoint any gaps or underrepresented areas. Subsequently, the system employs algorithms or rule-based logic to suggest a first API function type that complements or enhances the current API ecosystem. Additionally, feedback mechanisms and machine learning models might be integrated to refine and optimize this determination process continually, ensuring that the selected API function type aligns with both current needs and future scalability.

Process 200 may then select a first API onboarding template from a plurality of API onboarding templates (e.g., templates 204) based on the first API function type corresponding to the first API onboarding template. In some embodiments, the system identifies the first API function type, which defines the core functionality and purpose of the API to be onboarded. This identification may be achieved through analysis of the API's characteristics and intended use cases. Once the function type is determined, the system matches it against a repository of predefined onboarding templates, each designed to cater to specific API function types. These templates include detailed guidelines, configurations, and best practices tailored to various API functionalities, such as data access, processing, integration, or security. In some embodiments, the selection process involves comparing the attributes of the first API function type with the specifications and requirements outlined in each template. The system may evaluate factors such as data formats, communication protocols, security measures, and performance criteria to ensure compatibility and optimal performance. In some embodiments, the system may employ decision-making algorithms or machine learning models to automate this matching process, enhancing accuracy and efficiency.

At service 206, the system may perform a data gathering process that populates the first API onboarding template to generate a populated template. In some embodiments, the system may populate the template by retrieving information from database 208. For example, the system may detect a first field in the first API onboarding template corresponding to a first API characteristic, and the system may determine the first API characteristic for the API. In some embodiments, the API characteristic may be received from the user (e.g., via user interface 202). Alternatively or additionally, the system may retrieve known values and/or ranges for values from database 208 based on data in database 208. For example, database 208 may comprise subsets of audited and/or archived API data from production application data (e.g., data gathered during the operations of the application when in use).

For example, the system may identify and extract key characteristics of the new API, such as its endpoints, request and response formats, authentication methods, and data types. These characteristics provide the foundational information needed to fill out the onboarding template. Concurrently, the system may access audited and archived data from production applications, which include historical usage data, performance metrics, error logs, and user interaction patterns. This archived data is essential as it offers real-world insights into how similar APIs have functioned and interacted within the live environment. The system analyzes this data to identify trends, common issues, and optimal configurations that are relevant to the new API.

By correlating the new API's characteristics with the insights gained from the audited data, the system can make informed decisions about the best practices and configurations to include in the onboarding template. For example, if the archived data indicates a frequent issue with a specific type of request, the system can preemptively address this in the template by suggesting appropriate error handling mechanisms. Similarly, performance metrics can guide the configuration of rate limits and caching strategies. The system may then populate the onboarding template with this aggregated information, ensuring that the template is tailored to the specific needs and context of the new API. This populated template includes detailed instructions, configuration settings, and best practices that are informed by both the API's inherent characteristics and the historical data from similar APIs.

At model 210, the system may then generate, based on the populated template, a first feature input for a first artificial intelligence model. For example, the system may input the first feature input into the first artificial intelligence model to generate a first output, wherein the first artificial intelligence model comprises subsets of historical REST (Representational State Transfer) requests and REST responses transmitted by APIs previously onboarded to the first application labeled with a given type. In some embodiments, the system may use non-model based (or not artificial intelligence-based) solutions. For example, the system may have a standard routine or protocol for generating synthetic data based on a given template.

The system may then determine a plurality of synthetic REST requests based on the first output. As described herein, a synthetic REST request (or a synthetic request generally) is a simulated HTTP request designed to mimic a real REST request (or other request) used in web services and APIs. Unlike actual user-generated requests that arise from real-world interactions with an application, synthetic REST requests are artificially created for testing, monitoring, or performance assessment purposes. These requests replicate the structure, headers, parameters, and payloads of genuine REST requests to accurately emulate typical API usage scenarios. The primary goal of synthetic REST requests is to evaluate the behavior and performance of an API under controlled conditions. By generating these requests, developers and testers can assess how the API handles various types of inputs, stress test its limits, and identify potential issues such as latency, bottlenecks, or error rates. Synthetic requests can also be used to monitor the health and uptime of an API, ensuring that it responds correctly and efficiently to expected types of interactions. These requests are crafted based on predefined criteria and usage patterns, ensuring they closely resemble actual user behavior. Tools and scripts, often integrated into automated testing frameworks, generate these synthetic requests at specified intervals or under specific conditions. By leveraging synthetic REST requests, organizations can proactively maintain and improve their APIs, ensuring reliability and performance for end-users.

For example, the system may gather a comprehensive dataset of historical REST interactions (e.g., from database 208), which include detailed records of request formats, parameters, headers, payloads, and corresponding responses. These interactions are labeled according to their type, such as data retrieval, submission, or updates, reflecting their specific use cases and functions. The artificial intelligence model may be trained on this labeled dataset to recognize patterns, trends, and typical behaviors associated with each type of REST request and response. The model learns the nuances of how different types of requests are structured, how they interact with the API, and what kinds of responses they elicit. By understanding these patterns, the model can generate realistic synthetic REST requests that accurately mimic real-world usage scenarios.

Once the model is trained, the system utilizes its outputs to create synthetic requests. The model generates these requests by combining various elements observed in the historical data, such as common parameter combinations, typical payload structures, and frequently used endpoints. It ensures that the generated requests reflect the diversity and variability of actual requests while maintaining the specific characteristics associated with each type. These synthetic REST requests are then used to test and evaluate the API's performance, reliability, and scalability under controlled conditions. By leveraging the insights from historical data, the system can produce a wide range of realistic requests that simulate different user interactions and operational scenarios. This approach ensures comprehensive testing and monitoring, helping to identify potential issues and optimize the API's performance before it encounters real-world traffic.

API Calling Service 212 may then execute the plurality of synthetic REST requests to receive a plurality of synthetic REST responses. An API Calling Service may comprise a software component or platform designed to facilitate and manage the interactions between different software applications through APIs. This service acts as an intermediary that executes API calls, which are requests made by one application to access the functions and data of another application. The primary function of an API Calling Service is to simplify and standardize the process of making these calls, ensuring that requests are properly formatted, authenticated, and routed to the appropriate endpoints. In some embodiments, this may include determining one or more endpoints (e.g., endpoint 214).

API Calling Service 212 may determine whether to onboard the first API based on validating the plurality of synthetic REST responses. For example, API Calling Service 212 may log responses to the request at database 216. For example, API Calling Service 212 may execute a plurality of REST requests to receive a plurality of REST responses by following a structured and systematic approach. API Calling Service 212 may prepare the REST requests by gathering the necessary information, such as endpoints, HTTP methods (GET, POST, PUT, DELETE, etc.), headers, query parameters, and payloads. Each request is constructed based on predefined criteria or dynamically generated inputs, depending on the application's requirements. Once the requests are prepared, API Calling Service 212 manages the execution process, which may involve scheduling the requests to be sent either concurrently or sequentially. For concurrent execution, API Calling Service 212 may utilize parallel processing techniques, often employing multiple threads or asynchronous programming models to send multiple requests simultaneously. This approach maximizes efficiency and reduces the overall time needed to process a large number of requests. As each request is sent, API Calling Service 212 may ensure that it adheres to any necessary authentication and authorization protocols, such as including API keys, OAuth tokens, or other security measures. API Calling Service 212 may then wait for the responses from the target APIs. Upon receiving each response, the service processes it by validating the status codes, extracting relevant data from the response body, and handling any errors or exceptions that may occur. Throughout this process, API Calling Service 212 may also implement features such as rate limiting to prevent exceeding the API's usage quotas, retry mechanisms to handle transient failures, and logging to record the details of each request and response for monitoring and debugging purposes.

In response to determining to onboard the first API, process 200 may generate for display, on user interface 202, a validation confirmation to a first user. For example, the system may send a series of test requests from the new API, covering a range of expected use cases and scenarios. These requests are designed to trigger responses that evaluate the API's functionality, performance, reliability, and compliance with expected standards. Upon receiving the responses, the system analyzes one or more factors. For example, the system may assess the correctness and completeness of the responses to ensure that the API provides accurate and comprehensive data or services as expected. This involves verifying the response formats, data structures, and the relevance of the information returned. The system may evaluate the performance of the API by measuring response times, throughput, and scalability under varying loads. The system may check for any latency issues, bottlenecks, or performance degradation when the API handles multiple concurrent requests. The reliability of the API is also scrutinized by observing how consistently it performs under different conditions and by identifying any error rates or failure instances. The system may also ensure that the API responses adhere to security best practices, such as proper authentication, authorization, and encryption measures to protect data integrity and confidentiality. Additionally, the system may consider the API's compliance with industry standards and regulatory requirements, ensuring that it meets the necessary legal and technical criteria.

Based on this comprehensive analysis, the system generates a report summarizing the findings and highlighting any potential issues or risks. The system may then generate for display this report on user interface 202. For example, if the API meets the predefined thresholds for accuracy, performance, reliability, security, and compliance, the system may recommend onboarding the API. Conversely, if significant issues are detected, the system may suggest further improvements or reject the API for onboarding until the issues are resolved. This thorough evaluation process ensures that only high-quality, reliable, and secure APIs are integrated into the system, thereby maintaining the overall integrity and performance of the application ecosystem.

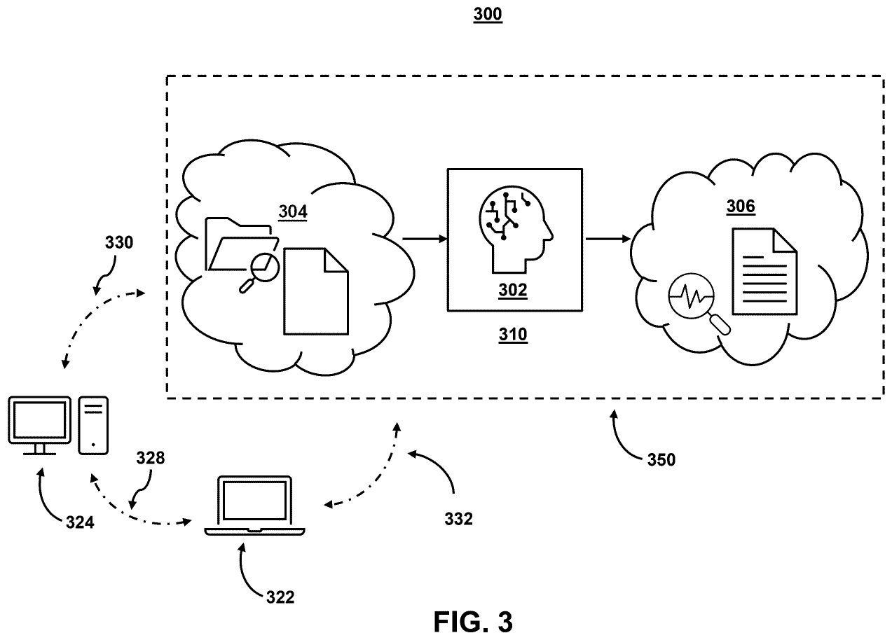

FIG. 3 shows illustrative components for a system used to perform API onboarding using an artificial intelligence model, in accordance with one or more embodiments. For example, system 300 may be used for API onboarding using API onboarding templates that generate feature inputs for artificial intelligence models trained on subsets of audited and/or archived API data from production application data. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., an API onboarding template, an API characteristic required for a template, a validation of an API response, a synthetically generated request, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., an API onboarding template, an API characteristic required for a template, a validation of an API response, a synthetically generated request, etc.).

In some embodiments, the model (e.g., model 302) may automatically perform actions based on outputs 306. In some embodiments, the model (e.g., model 302) may not perform any actions. The output of the model (e.g., model 302) may be used to select an API onboarding template, an API characteristic required for a template, whether to validate an API, how to generate a synthetic request, etc.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

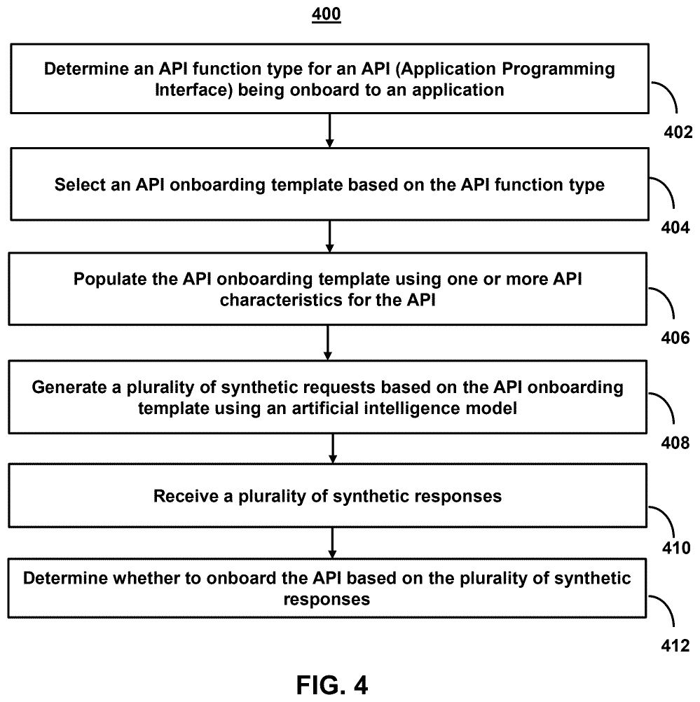

FIG. 4 shows a flowchart of the steps involved in API onboarding using an API onboarding template, in accordance with one or more embodiments. For example, the system may use process 400 (e.g., as implemented on one or more system components described above) in order to facilitate API onboarding using API onboarding templates that generate feature inputs for artificial intelligence models trained on subsets of audited and/or archived API data from production application data.

At step 402, process 400 (e.g., using one or more components described above) determines an API function type for an API being onboard to an application. For example, the system may determine a first API function type for a first API (Application Programming Interface) being onboard to a first application. In some embodiments, the system may receive a first user request to onboard a first API to a first application and determine a first API function type (e.g., based on a manual input or automatically) for the first API.

In some embodiments, the system may select the first API onboarding template from the plurality of API onboarding templates based on receiving a second user request to validate a first API functionality for the first API and verifying that the first API onboarding template corresponds to the first API functionality. For example, the system may analyze the specific functionality of the first API that needs to be validated. This analysis involves understanding the core purpose of the API, such as data retrieval, transaction processing, user authentication, or any other defined functionality. The system may review the available API onboarding templates, each designed to cater to different types of API functionalities. These templates typically contain predefined configurations, validation steps, best practices, and documentation requirements tailored to specific API functions. The system may identify key characteristics and requirements outlined in the user request and maps these to the functionalities and features detailed in each template. The system may verify which of the onboarding templates corresponds to the first API functionality. This involves checking the compatibility of the template's structure and guidelines with the API's specified functionality. For instance, if the API is intended for user authentication, the system looks for a template that includes fields and validation steps related to security protocols, token management, and user credential handling. The system may ensure that the selected template aligns with the first API's functional requirements by examining critical aspects such as endpoint configurations, data formats, authentication methods, error handling procedures, and performance benchmarks. This verification process may involve cross-referencing the API's technical documentation with the template's specifications to confirm a suitable match.

In some embodiments, the system may select the first API onboarding template from the plurality of API onboarding templates based on receiving a second user request to validate a first data type for the first API and verifying that the first API onboarding template corresponds to the first data type. For example, upon receiving the second user request, which specifies the need to validate a particular data type for the first API, the system may initiate the process by identifying the characteristics and requirements associated with the specified data type. This includes understanding the data format, structure, schema, and any specific validation rules pertinent to the data type, such as numerical values, text strings, dates, or complex JSON objects. The system may then review the available API onboarding templates, each tailored to handle different data types and their associated validation processes. These templates encompass predefined configurations, validation checks, best practices, and documentation that are specific to various data types. The system analyzes the templates to identify which ones are designed to support the data type specified in the user request. To verify that a template corresponds to the first data type, the system may examine the details of each template, focusing on how they handle data validation, data transformation, and error checking related to the specified data type. This involves checking for fields and validation steps that align with the characteristics of the data type. For example, if the data type is a date, the system looks for templates that include date format validation, range checks, and handling of time zones.

In some embodiments, the system may select the first API onboarding template from the plurality of API onboarding templates based on determining a second API that is dependent to the first API and verifying that the first API onboarding template corresponds to calling the second API to validate the first API. Upon identifying that the first API has a dependency on the second API, the system may begin by analyzing the nature of this dependency. This analysis involves understanding how the first API interacts with the second API, including the specific endpoints, request and response formats, authentication mechanisms, and the sequence of calls required.

The system then reviews the available API onboarding templates, each designed to handle various scenarios, including those involving inter-API dependencies. These templates include predefined workflows, configuration settings, and validation steps tailored to different types of API interactions. The system's goal is to identify templates that are specifically designed to manage and validate API dependencies, ensuring that the first API's functionality is accurately tested in conjunction with the second API. To verify that a template corresponds to the need for calling the second API to validate the first API, the system examines the templates for key features and instructions related to inter-API communication. This includes checking for fields and validation steps that outline how to set up calls to the second API, handle its responses, and use these responses to validate the behavior of the first API. For instance, the template should specify how to configure the authentication for both APIs, the sequence of API calls, and the expected data flow between them. The system cross-references the dependencies and interactions specified in the technical documentation of both APIs with the details provided in each onboarding template. This ensures that the selected template can facilitate the required integration and validation processes. The verification process may involve confirming that the template includes guidelines for handling various dependency scenarios, such as synchronous and asynchronous API calls, error handling across multiple APIs, and performance testing of the integrated system.

At step 404, process 400 (e.g., using one or more components described above) selects an API onboarding template based on the API function type. For example, the system may select a first API onboarding template from a plurality of API onboarding templates based on the first API function type corresponding to the first API onboarding template. For example, each of the plurality of API onboarding templates may comprise a respective subset of fields for receiving API characteristics, wherein the respective subset of fields are determined by a second artificial intelligence model, and wherein the second artificial intelligence model is trained to determine the respective subset of fields using second training data.

In some embodiments, the system may train a second artificial intelligence model by receiving the subsets of historical requests and responses transmitted by the APIs previously onboarded to the first application labeled with the given function type, generating the second training data based on the subsets of historical requests and responses, determining, based on the second training data, subsets of API characteristics corresponding to the subsets of historical requests and responses with the given function type, and determining the respective subset of fields based on the subsets of API characteristics. In some embodiments, the subsets of historical requests and responses may comprise historical REST requests and REST responses transmitted by APIs previously onboarded to the first application labeled with a given type, and wherein the first plurality of synthetic requests comprises a plurality of synthetic REST requests.

For example, the system may receive subsets of historical requests and responses transmitted by APIs previously onboarded to a first application. These historical data sets are labeled with a given function type, categorizing the data based on the specific purposes and functionalities of the APIs, such as data retrieval, submission, or updates. The system may process these labeled historical data subsets to generate the second training data. This involves extracting relevant features from the historical requests and responses, such as endpoint URLs, HTTP methods, headers, query parameters, request payloads, and response formats. By analyzing these interactions, the system identifies patterns and commonalities that are characteristic of the APIs with the given function type.

Using this extracted information, the system may generate the second training data, which now includes structured representations of the historical requests and responses, along with their associated features. This training data serves as the foundation for training the second artificial intelligence model. The model learns to recognize the typical structures, contents, and behaviors associated with different function types by being exposed to this comprehensive dataset. During the training process, the model is adjusted and fine-tuned to accurately identify and predict API characteristics based on the historical data. The system then uses the trained model to determine subsets of API characteristics corresponding to the historical requests and responses with the given function type. These characteristics might include specific API endpoints, expected input and output formats, authentication mechanisms, and typical response behaviors. Subsequently, the system may identify the respective subset of fields within the onboarding template that correspond to these determined API characteristics. For instance, if the historical data indicates a common endpoint structure for data retrieval APIs, the system maps this characteristic to the relevant fields in the template, such as “Endpoint URL” and “Request Method.” Similarly, authentication requirements and response formats are mapped to their corresponding fields.

At step 406, process 400 (e.g., using one or more components described above) populates the API onboarding template using one or more API characteristics for the API. For example, the system may populate the first API onboarding template to generate a populated template using one or more API characteristics for the first API.

In some embodiments, the system may populate the first API onboarding template to generate the populated template using the one or more API characteristics by detecting one or more fields in the first API onboarding template corresponding to one or more API characteristics. The system may then populate the field with a determined API characteristic for the API. For example, the system may analyze the structure of the API onboarding template, identifying all necessary fields that require input. These fields typically include essential API details such as endpoint URLs, request methods (GET, POST, PUT, DELETE), authentication requirements, headers, query parameters, request and response formats, and error handling procedures. The system may then examine the API documentation and metadata to extract relevant characteristics. For instance, it identifies the base URL for the API endpoints, the supported HTTP methods for each endpoint, the necessary authentication mechanisms (such as API keys or OAuth tokens), and any required headers or parameters. The system may also look at the expected request and response payload structures, including data types and formats, and any specific error codes and messages that the API might return. Once the system has gathered this information, the system may match each piece of data to the corresponding fields in the onboarding template. Using pattern recognition and mapping algorithms, the system detects which API characteristics align with the template fields. For example, if the template has a field labeled “Base URL,” the system populates it with the API's base endpoint. Similarly, if there are fields for “Request Methods,” “Headers,” and “Response Formats,” these are filled with the extracted details of the API's supported methods, required headers, and response structures, respectively. To ensure accuracy, the system may validate the populated fields against the API specifications, checking for consistency and completeness. This validation step helps identify any discrepancies or missing information that need to be addressed.

After populating the template with all relevant API characteristics, the system generates the final populated onboarding template. This document now contains all the necessary configuration details, guidelines, and best practices for integrating the new API into the existing system. For example, the system may detect a first field in the first API onboarding template corresponding to a first API characteristic. The system may determine the first API characteristic for the API. The system may detect a second field in the first API onboarding template corresponding to a second API characteristic. The system may determine the second API characteristic for the API.

At step 408, process 400 (e.g., using one or more components described above) generates a plurality of synthetic requests based on the API onboarding template using an artificial intelligence model. For example, the system may input a first feature input, based on the populated template, into a first artificial intelligence model to generate a first plurality of synthetic requests, wherein the first artificial intelligence model is trained to generate synthetic requests using first training data, and wherein the first training data comprises subsets of historical requests and responses transmitted by APIs previously onboarded to the first application labeled with a given function type. In some embodiments, the system may generate, based on the populated template, a first feature input for a first artificial intelligence model. The system may then input the first feature input into the first artificial intelligence model to generate a first output. The system may then determine a first plurality of synthetic requests based on the first output.

In some embodiments, training the first artificial intelligence model to generate the synthetic requests using the first training data may comprise receiving the subsets of historical requests and responses transmitted by the APIs previously onboarded to the first application labeled with the given function type, generating the first training data comprising the synthetic requests and validated responses based on labeled API characteristics, and determining, based on the first training data, the first plurality of synthetic requests based on the one or more API characteristics for the first API.

For example, the system may collect and receive subsets of historical requests and responses transmitted by the APIs previously onboarded to the first application. These historical data sets are labeled according to their function type, which provides context and categorizes the requests and responses based on their specific use cases and operational purposes. The system then processes this labeled data to generate the first training data. This involves analyzing the historical requests and responses to identify patterns, common structures, and typical interactions. The system extracts relevant features from these interactions, such as endpoint URLs, request methods, headers, query parameters, payload formats, and response patterns. These extracted features form the basis for creating synthetic requests that accurately mimic real-world API interactions.

Using these features, the system generates synthetic requests and pairs them with validated responses. The validated responses are crafted to reflect realistic API behavior, ensuring that the synthetic requests elicit appropriate and expected responses. This step involves leveraging the labeled API characteristics to ensure that the generated synthetic requests and responses align with the typical usage patterns and functional requirements of the given function type. With the first training data comprising these synthetic requests and validated responses, the system trains the artificial intelligence model. The model learns to recognize and replicate the characteristics of real API interactions by being exposed to this comprehensive dataset. The training process involves adjusting the model's parameters and algorithms to accurately generate synthetic requests that closely resemble historical requests in terms of structure, content, and behavior. Once the model is trained, the system determines the first plurality of synthetic requests for the first API based on the one or more API characteristics. This involves inputting the specific characteristics of the new API into the trained model, which then generates synthetic requests that reflect these characteristics. The model uses its learned knowledge to create requests that are functionally accurate and representative of potential real-world interactions with the API. Through this process, the system ensures that the synthetic requests generated for the new API are based on validated patterns and are tailored to the API's specific characteristics. This approach enables comprehensive testing and evaluation of the new API, ensuring it performs reliably and meets expected standards before being fully integrated into the application ecosystem.

At step 410, process 400 (e.g., using one or more components described above) receiving a plurality of synthetic responses. For example, the system may execute the first plurality of synthetic requests to receive a first plurality of synthetic responses. To do so, the system may generate synthetic requests that mimic typical API calls, ensuring that these requests cover a range of scenarios and use cases relevant to the API being tested. These synthetic requests are crafted based on predefined parameters, including various HTTP methods (such as GET, POST, PUT, DELETE), endpoint URLs, headers, query parameters, and payload data. As the API and/or application processes the synthetic requests, the system collects the resulting synthetic responses. These responses include status codes, response headers, and payload data, which the system records for further analysis. The system employs logging and monitoring tools to capture detailed information about each interaction, including response times, error messages, and any deviations from expected behavior.

At step 412, process 400 (e.g., using one or more components described above) determines whether to onboard the API based on the plurality of synthetic responses. For example, the system may determine whether to onboard the first API based on validating the first plurality of synthetic responses. For example, the system may determine to validate the first plurality of synthetic responses. In response to determining validate the first plurality of synthetic responses, the system may determine to onboard the first API. In response to determining to onboard the first API, the system may generate for display, on a user interface, a validation confirmation to a first user. Alternatively, the system may determine to not validate the first plurality of synthetic responses. In response to determining to not validate the first plurality of synthetic responses, the system may determine to onboard the first API. In response to determining to onboard the first API, the system may generate for display, on a user interface, an error notification to a first user.

The system may also iteratively generate additional synthetic requests. For example, in response to determining validate (or not to validate) the first plurality of synthetic responses, the system may determine a second plurality of synthetic requests. The system may execute the second plurality of synthetic requests to receive a second plurality of synthetic responses. The system may determine whether to onboard the first API based on validating the second plurality of synthetic responses.

In some embodiments, the system may validate the first plurality of synthetic responses to determine whether to onboard the first API by determining respective API endpoints for the first plurality of synthetic requests and validating the respective API endpoints. For example, the system may generate a first plurality of synthetic requests tailored to the expected use cases and functionalities of the new API. These synthetic requests are designed to simulate real-world interactions, covering various scenarios that the API might encounter once deployed. Upon sending these synthetic requests, the system may receive the corresponding synthetic responses from the API. The validation process begins by identifying and determining the respective API endpoints involved in each synthetic request. This involves mapping each request to its designated endpoint, verifying that the endpoints are correctly implemented and accessible as per the API's specifications. To validate these respective API endpoints, the system conducts several checks. It first ensures that the endpoints respond correctly to the synthetic requests by examining the status codes, response times, and payload structures. The system checks for proper adherence to HTTP status codes, such as 200 for successful responses, 404 for not found, and 500 for server errors, to ensure that the API handles requests and errors appropriately.

The system may validate the data returned in the responses. This includes verifying the accuracy, completeness, and format of the data against predefined criteria and expected outcomes. For instance, if a synthetic request is designed to fetch user data, the system checks whether the response includes all required user details in the correct format. Additionally, the system assesses the performance of each endpoint by measuring response times and ensuring that they fall within acceptable thresholds, indicating that the API can handle requests efficiently. The system may also check for consistency in the responses, ensuring that similar requests yield consistent results, which is crucial for reliability. Security aspects are validated by ensuring that sensitive data is properly protected and that the API endpoints adhere to security best practices, such as requiring appropriate authentication and authorization mechanisms. By thoroughly validating the respective API endpoints for the synthetic requests, the system determines whether the first API meets the necessary standards and requirements for onboarding. If the endpoints perform reliably, return accurate and complete data, and adhere to performance and security standards, the system may recommend onboarding the API. Conversely, if significant issues are identified, the system may suggest further refinement and retesting before the API can be integrated into the application ecosystem.

In some embodiments, validating the first plurality of synthetic responses to determine whether to onboard the first API may comprise the system determining respective functions for the first plurality of synthetic requests and validating the respective functions. For example, upon receiving synthetic responses from the API, the system may identify the specific functions each request is meant to test. This may involve mapping each synthetic request to its corresponding function, such as retrieving user data, processing transactions, or updating records. The system may ensure that the requests are appropriately aligned with the API's advertised capabilities and endpoints.

The system may evaluate the correctness of the responses by checking whether they match the expected outputs for each function. This includes verifying that the data returned is accurate, complete, and formatted according to the API's specifications. For instance, if a synthetic request is intended to retrieve a list of users, the system checks that the response includes all required user details in the correct structure. The system may assess the performance of the API functions by measuring response times and ensuring they fall within acceptable limits. This step is crucial to determine if the API can handle requests efficiently under different load conditions. The system also examines the consistency of the responses, ensuring that repeated requests yield similar results, which is vital for reliability and predictability. The system may further validate the handling of edge cases and error scenarios. This involves sending synthetic requests designed to test the API's response to invalid inputs, unexpected conditions, and potential error states. The system checks that the API responds with appropriate error codes, messages, and recovery mechanisms, demonstrating robust error handling and resilience.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for API (Application Programming Interface) onboarding using API onboarding templates that generate feature inputs for artificial intelligence models trained on subsets of audited and/or archived API data from production application data.
2. The method of any one of the preceding embodiments, further comprising: receiving a first user request to onboard a first API to a first application; determining a first API function type for the first API; selecting a first API onboarding template from a plurality of API onboarding templates based on the first API function type corresponding to the first API onboarding template; populating the first API onboarding template to generate a populated template using one or more API characteristics for the first API; generating, based on the populated template, a first feature input for a first artificial intelligence model; inputting the first feature input into the first artificial intelligence model to generate a first output, wherein the first artificial intelligence model is trained to generate synthetic requests using first training data, and wherein the first training data comprises subsets of historical requests and responses transmitted by APIs previously onboarded to the first application labeled with a given function type; determining a first plurality of synthetic requests; executing the first plurality of synthetic requests to receive a first plurality of synthetic responses; and determining whether to onboard the first API based on validating the first plurality of synthetic responses.
3. The method of any one of the preceding embodiments, wherein populating the first API onboarding template to generate the populated template using the one or more API characteristics further comprises: detecting a first field in the first API onboarding template corresponding to a first API characteristic; determining the first API characteristic for the API; detecting a second field in the first API onboarding template corresponding to a second API characteristic; and determining the second API characteristic for the API.
4. The method of any one of the preceding embodiments, wherein training the first artificial intelligence model to generate the synthetic requests using the first training data further comprises: receiving the subsets of historical requests and responses transmitted by the APIs previously onboarded to the first application labeled with the given function type; generating the first training data comprising the synthetic requests and validated responses based on labeled API characteristics; and determining, based on the first training data, the first plurality of synthetic requests based on the one or more API characteristics for the first API.
5. The method of any one of the preceding embodiments, wherein each of the plurality of API onboarding templates comprises a respective subset of fields for receiving API characteristics, wherein the respective subset of fields are determined by a second artificial intelligence model, and wherein the second artificial intelligence model is trained to determine the respective subset of fields using second training data.
6. The method of any one of the preceding embodiments, wherein training the second artificial intelligence model further comprises: receiving the subsets of historical requests and responses transmitted by the APIs previously onboarded to the first application labeled with the given function type; generating the second training data based on the subsets of historical requests and responses; determining, based on the second training data, subsets of API characteristics corresponding to the subsets of historical requests and responses with the given function type; and determining the respective subset of fields based on the subsets of API characteristics.
7. The method of any one of the preceding embodiments, wherein the subsets of historical requests and responses comprises historical REST (Representational State Transfer) requests and REST responses transmitted by APIs previously onboarded to the first application labeled with a given type, and wherein the first plurality of synthetic requests comprises a plurality of synthetic REST requests.
8. The method of any one of the preceding embodiments, wherein validating the first plurality of synthetic responses to determine whether to onboard the first API further comprises: determining respective API endpoints for the first plurality of synthetic requests; and validating the respective API endpoints.
9. The method of any one of the preceding embodiments, wherein validating the first plurality of synthetic responses to determine whether to onboard the first API further comprises: determining respective functions for the first plurality of synthetic requests; and validating the respective functions.
10. The method of any one of the preceding embodiments, wherein determining whether to onboard the first API based on validating the first plurality of synthetic responses further comprises: determining to validate the first plurality of synthetic responses; in response to determining validate the first plurality of synthetic responses, determining to onboard the first API; and in response to determining to onboard the first API, generating for display, on a user interface, a validation confirmation to a first user.
11. The method of any one of the preceding embodiments, wherein determining whether to onboard the first API based on validating the first plurality of synthetic responses further comprises: determining to not validate the first plurality of synthetic responses; in response to determining to not validate the first plurality of synthetic responses, determining to onboard the first API; and in response to determining to onboard the first API, generating for display, on a user interface, an error notification to a first user.
12. The method of any one of the preceding embodiments, wherein determining whether to onboard the first API based on validating the first plurality of synthetic responses further comprises: determining to validate the first plurality of synthetic responses; in response to determining validate the first plurality of synthetic responses, determining to onboard the first API; determining a second plurality of synthetic requests; executing the second plurality of synthetic requests to receive a second plurality of synthetic responses; and determining whether to onboard the first API based on validating the second plurality of synthetic responses.
13. The method of any one of the preceding embodiments, wherein selecting the first API onboarding template from the plurality of API onboarding templates is further based on: receiving a second user request to validate a first API functionality for the first API; and verifying that the first API onboarding template corresponds to the first API functionality.
14. The method of any one of the preceding embodiments, wherein selecting the first API onboarding template from the plurality of API onboarding templates is further based on: receiving a second user request to validate a first data type for the first API; and verifying that the first API onboarding template corresponds to the first data type.
15. The method of any one of the preceding embodiments, wherein selecting the first API onboarding template from the plurality of API onboarding templates is further based on: determining a second API that is dependent to the first API; verifying that the first API onboarding template corresponds to calling the second API to validate the first API.
16. One or more non-transitory, computer-readable mediums storing instructions that, when executed by a data processing apparatus, cause the data processing apparatus to perform operations comprising those of any of embodiments 1-15.
17. A system comprising one or more processors; and memory storing instructions that, when executed by the processors, cause the processors to effectuate operations comprising those of any of embodiments 1-15.
18. A system comprising means for performing any of embodiments 1-15.

What is claimed is:

1. A system for API (Application Programming Interface) onboarding using API onboarding templates that generate feature inputs for artificial intelligence models trained on subsets of audited and/or archived API data from production application data, the system comprising:
receiving a first user request to onboard a first API to a first application;
determining a first API function type for the first API;
selecting a first API onboarding template from a plurality of API onboarding templates based on the first API function type corresponding to the first API onboarding template;
populating the first API onboarding template to generate a populated template by:
detecting a first field in the first API onboarding template corresponding to a first API characteristic;
determining the first API characteristic for the API;
detecting a second field in the first API onboarding template corresponding to a second API characteristic; and
determining the second API characteristic for the API;
generating, based on the populated template, a first feature input for a first artificial intelligence model;
inputting the first feature input into the first artificial intelligence model to generate a first output, wherein the first artificial intelligence model comprises subsets of historical REST (Representational State Transfer) requests and REST responses transmitted by APIs previously onboarded to the first application labeled with a given type;
determining a plurality of synthetic REST requests based on the first output;
executing the plurality of synthetic REST requests to receive a plurality of synthetic REST responses;
determining whether to onboard the first API based on validating the plurality of synthetic REST responses; and
in response to determining to onboard the first API, generating for display, on a user interface, a validation confirmation to a first user.

2. A method for API (Application Programming Interface) onboarding using API onboarding templates that generate feature inputs for artificial intelligence models trained on subsets of audited and/or archived API data from production application data, the method comprising:
receiving a first user request to onboard a first API to a first application;
determining a first API function type for the first API;
selecting a first API onboarding template from a plurality of API onboarding templates based on the first API function type corresponding to the first API onboarding template;
populating the first API onboarding template to generate a populated template using one or more API characteristics for the first API;
generating, based on the populated template, a first feature input for a first artificial intelligence model;
inputting the first feature input into the first artificial intelligence model to generate a first output, wherein the first artificial intelligence model is trained to generate synthetic requests using first training data, and wherein the first training data comprises subsets of historical requests and responses transmitted by APIs previously onboarded to the first application labeled with a given function type;
determining a first plurality of synthetic requests based on the first output;
executing the first plurality of synthetic requests to receive a first plurality of synthetic responses; and
determining whether to onboard the first API based on validating the first plurality of synthetic responses.

3. The method of claim 2, wherein populating the first API onboarding template to generate the populated template using the one or more API characteristics further comprises:
detecting a first field in the first API onboarding template corresponding to a first API characteristic;
determining the first API characteristic for the API;
detecting a second field in the first API onboarding template corresponding to a second API characteristic; and
determining the second API characteristic for the API.

4. The method of claim 2, wherein training the first artificial intelligence model to generate the synthetic requests using the first training data further comprises:
receiving the subsets of historical requests and responses transmitted by the APIs previously onboarded to the first application labeled with the given function type;
generating the first training data comprising the synthetic requests and validated responses based on labeled API characteristics; and
determining, based on the first training data, the first plurality of synthetic requests based on the one or more API characteristics for the first API.

5. The method of claim 2, wherein each of the plurality of API onboarding templates comprises a respective subset of fields for receiving API characteristics, wherein the respective subset of fields are determined by a second artificial intelligence model, and wherein the second artificial intelligence model is trained to determine the respective subset of fields using second training data.

6. The method of claim 5, wherein training the second artificial intelligence model further comprises:
receiving the subsets of historical requests and responses transmitted by the APIs previously onboarded to the first application labeled with the given function type;
generating the second training data based on the subsets of historical requests and responses;
determining, based on the second training data, subsets of API characteristics corresponding to the subsets of historical requests and responses with the given function type; and
determining the respective subset of fields based on the subsets of API characteristics.

7. The method of claim 2, wherein the subsets of historical requests and responses comprises historical REST (Representational State Transfer) requests and REST responses transmitted by APIs previously onboarded to the first application labeled with a given type, and wherein the first plurality of synthetic requests comprises a plurality of synthetic REST requests.

8. The method of claim 2, wherein validating the first plurality of synthetic responses to determine whether to onboard the first API further comprises:
determining respective API endpoints for the first plurality of synthetic requests; and
validating the respective API endpoints.

9. The method of claim 2, wherein validating the first plurality of synthetic responses to determine whether to onboard the first API further comprises:
determining respective functions for the first plurality of synthetic requests; and
validating the respective functions.

10. The method of claim 2, wherein determining whether to onboard the first API based on validating the first plurality of synthetic responses further comprises:
determining to validate the first plurality of synthetic responses;
in response to determining validate the first plurality of synthetic responses, determining to onboard the first API; and
in response to determining to onboard the first API, generating for display, on a user interface, a validation confirmation to a first user.

11. The method of claim 2, wherein determining whether to onboard the first API based on validating the first plurality of synthetic responses further comprises:
determining to not validate the first plurality of synthetic responses;
in response to determining to not validate the first plurality of synthetic responses, determining to onboard the first API; and
in response to determining to onboard the first API, generating for display, on a user interface, an error notification to a first user.

12. The method of claim 2, wherein determining whether to onboard the first API based on validating the first plurality of synthetic responses further comprises:
determining to validate the first plurality of synthetic responses;
in response to determining validate the first plurality of synthetic responses, determining a second plurality of synthetic requests;
executing the second plurality of synthetic requests to receive a second plurality of synthetic responses; and
determining whether to onboard the first API based on validating the second plurality of synthetic responses.

13. The method of claim 2, wherein selecting the first API onboarding template from the plurality of API onboarding templates is further based on:
receiving a second user request to validate a first API functionality for the first API; and
verifying that the first API onboarding template corresponds to the first API functionality.

14. The method of claim 2, wherein selecting the first API onboarding template from the plurality of API onboarding templates is further based on:
receiving a second user request to validate a first data type for the first API; and
verifying that the first API onboarding template corresponds to the first data type.

15. The method of claim 2, wherein selecting the first API onboarding template from the plurality of API onboarding templates is further based on:
determining a second API that is dependent to the first API; and
verifying that the first API onboarding template corresponds to calling the second API to validate the first API.

16. One or more non-transitory, computer-readable mediums, comprising instructions that, when executed by one or more processors, cause operations comprising:
determining a first API function type for a first API (Application Programming Interface) being onboard to a first application;
selecting a first API onboarding template from a plurality of API onboarding templates based on the first API function type corresponding to the first API onboarding template;
populating the first API onboarding template to generate a populated template using one or more API characteristics for the first API;
inputting a first feature input, based on the populated template, into a first artificial intelligence model to generate a first plurality of synthetic requests, wherein the first artificial intelligence model is trained to generate synthetic requests using first training data, and wherein the first training data comprises subsets of historical requests and responses transmitted by APIs previously onboarded to the first application labeled with a given function type;
executing the first plurality of synthetic requests to receive a first plurality of synthetic responses; and
determining whether to onboard the first API based on validating the first plurality of synthetic responses.

17. The one or more non-transitory, computer-readable mediums of claim 16, wherein populating the first API onboarding template to generate the populated template using the one or more API characteristics further comprises:
detecting a first field in the first API onboarding template corresponding to a first API characteristic;
determining the first API characteristic for the first API;
detecting a second field in the first API onboarding template corresponding to a second API characteristic; and
determining the second API characteristic for the first API.

18. The one or more non-transitory, computer-readable mediums of claim 16, wherein training the first artificial intelligence model to generate the synthetic requests using the first training data further comprises:
receiving the subsets of historical requests and responses transmitted by the APIs previously onboarded to the first application labeled with the given function type;
generating the first training data comprising the synthetic requests and validated responses based on labeled API characteristics; and
determining, based on the first training data, the first plurality of synthetic requests based on the one or more API characteristics for the first API.

19. The one or more non-transitory, computer-readable mediums of claim 16, wherein each of the plurality of API onboarding templates comprises a respective subset of fields for receiving API characteristics, wherein the respective subset of fields are determined by a second artificial intelligence model, and wherein the second artificial intelligence model is trained to determine the respective subset of fields using second training data.

20. The one or more non-transitory, computer-readable mediums of claim 19, wherein training the second artificial intelligence model to determine the respective subset of fields using the second training data that comprises the subsets of historical requests and responses transmitted by the APIs previously onboarded to the first application labeled with the given function type further comprises:
receiving the subsets of historical requests and responses transmitted by the APIs previously onboarded to the first application labeled with the given function type;
generating the second training data based on the subsets of historical requests and responses;
determining, based on the second training data, subsets of API characteristics corresponding to the subsets of historical requests and responses with the given function type; and
determining the respective subset of fields based on the subsets of API characteristics.
